(19) United States
(12) Patent Application Publication
(10) Pub. No.: US 2006/0179051 A1
(43) Pub. Date: Aug. 10, 2006

(54) Methods and apparatus for steering the analyses of collections of documents

(75) Inventors: Paul D. Whitney, Richland, WA (US); Susan L. Havre, Richland, WA (US); David R. McGee, Portland, OR (US)

Correspondence Address: WELLS ST. JOHN P.S., 601 WEST FIRST AVENUE, SUITE 1300, SPOKANE, WA, 99201-3828, US

(73) Assignee: Battelle Memorial Institute

(21) Appl. No.: 11/268,283

(22) Filed: Nov. 3, 2005

Related U.S. Application Data
(60) Provisional application No. 60/651,841, filed on Feb. 9, 2005.

(51) Int. Cl. G06F 17/30

(52) U.S. Cl. 707/5

(57) ABSTRACT

A method for steering the analysis of a collection of documents includes receiving query terms for use in querying a database including a collection of documents; representing at least some of the query terms in a matrix; rotating document vectors associated with the documents to match the matrix to produce a matrix of rotated document vectors, each document vector representing a numeric vector created in association with individual documents; grouping the rotated document vectors into clusters, each cluster having one or more documents; and projecting the clusters to display visual information of the documents, the visual information including a summary view of the collection of documents. Program code and a system are also provided.

### CROSS REFERENCE TO RELATED APPLICATION

This application claims priority from U.S. Provisional Application Serial No. 60/651,841 filed Feb. 9, 2005 and incorporated by reference herein.

### GOVERNMENT RIGHTS STATEMENT

This invention was made with Government support under Contract DE-AC0676RL01830 awarded by the U.S. Department of Energy. The Government has certain rights in the invention.

### TECHNICAL FIELD

The invention relates to systems and methods for analyzing and/or characterizing the content of electronic documents.

### BACKGROUND OF THE INVENTION

As the global economy has become increasingly driven by the skillful synthesis of information across all disciplines, be they scientific, economic, or otherwise, the sheer volume of information available for use in such a synthesis has rapidly expanded. This has resulted in an ever increasing value for systems or methods which are able to analyze information and separate information relevant to a particular problem or useful in a particular inquiry from information that is not relevant or useful. The vast majority of information available for such synthesis, 95% according to estimates by the National Institute or Science and Technology (NIST), is in the form of written natural language. The traditional method of analyzing and characterizing information in the form of written natural language is to simply read it. However, this approach is increasingly unsatisfactory as the sheer volume of information outpaces the time available for manual review. Thus, several methodologies for automating the analysis and characterization of such information have arisen. Typical for such schemes is the requirement that the information is presented, or converted, to an electronic form or database, thereby allowing the database to be manipulated by a computer system according to a variety of algorithms designed to analyze and/or characterize the information available in the database. For example, vector based systems using first order statistics have been developed which attempt to define relationships between documents based upon simple characteristics of the documents, such as word counts.

The simplest of these methodologies is a simple search wherein a word or a word form is entered into the computer as a query and the computer compares the query to words contained in the documents in the database to determine if matches exist. If there are matches, the computer then returns a list of those documents within the database which contain a word or word form which matches the query. This simple search methodology may be expanded by the addition of other Boolean operators into the query. For example, the computer may be asked to search for documents which contain both a first query and a second query, or a second query within a predetermined number of words from the first query, or for documents containing a query, which consist of a series of terms, of for documents which contain a particular query but not another query. Whatever the particular parameters, the computer searches the database for documents which fit the required parameters, and those documents are then returned to the user.

Among the drawbacks of such schemes is the possibility that in a large database, even a very specific query may match a number of documents that is too large to be effectively reviewed by the user. Additionally, given any particular query, there exists the possibility that documents which would be relevant to the user may be overlooked because the documents do not contain the specific query term identified by the user; in other words, these systems often ignore word to word relationships, and thus require exacting queries to insure meaningful search results. Because these systems tend to require exacting queries, these methods suffer from the drawback that the user must have some concept of the contents of the documents in order to draft a query which will generate the desired results. This presents the users of such systems with a fundamental paradox: In order to become familiar with a database, the user must ask the right questions or enter relevant queries; however, to ask the right questions or enter relevant queries, the user must already be familiar with the database.

To overcome these and other drawbacks, a number of methods have arisen which are intended to compare the contents of documents in an electronic database and thereby determine relationships between the documents. In this manner, documents that address similar subject matter but do not share common key words may be linked, and queries to the database are able to generate resulting relevant documents without requiring exacting specificity in the query parameters. For example, vector based systems using higher order statistics may be characterized by the generation of vectors which can be used to compare documents. By measuring conditional probabilities between and among words contained within the database, different terms may be linked together. However, these systems suffer from the drawback that they are unable to discern words which provide insight into the meaning of the documents which contain them. Other systems have sought to overcome this limitation by utilizing neural networks or other methods to capture the higher order statistics required to compress the vector space. These systems suffer from considerable computational lag due to the large amount of information that they are processing. Thus, there exists a need for an automated system which will analyze and characterize a database of electronically formatted natural language based documents in a manner wherein the system output correlates documents within the database according to the meaning of the documents and required system resources are minimized.

U.S. Pat. No. 6,484,168 to Pennock et al. (incorporated herein by reference) discloses a System for Information Discovery (SID). The intent of Pennock et al. is to provide a system for analyzing and characterizing a database of electronically formatted natural language based documents wherein the output is information concerning the content and structure of the underlying database in a form that correlates the meaning of the individual documents within the database. A sequence of word filters are used to eliminate terms in the database which do not discriminate document content, resulting in a filtered word set whose members are highly predictive of content. The filtered word set is then further reduced to determine a subset of topic words which are characterized as the set of filtered words which best discriminate the content of the documents which contain them. These two word sets, the filtered word set and the topic set, are then formed into a two dimensional matrix. Matrix entries are then calculated as the conditional probability that a document will contain a word in a row given that it contains the word in the column of the matrix. The number of word correlations which is computed is thus significantly reduced because each word in the filtered set is only related to the topic words, with the topic word set being smaller than the filtered word set. The matrix representation thus captures the context of the filtered words and allows the resultant vectors to be utilized to interpret document contents with a wide variety of querying schemes. Surprisingly, while computational efficiency gains are realized by utilizing the reduced topic word set (as compared with creating a matrix with only the filtered word set forming both the columns and the rows), the ability of the resultant vectors to predict content is comparable or superior to approaches which consider word sets which have not been reduced either in the number of terms considered or by the number of correlations between terms.

The first step of the Pennock et al. system is to compress the vocabulary of the database through a series of filters. Three filters are employed, the frequency filter, the topicality filter and the overlap filter. The frequency filter first measures the absolute number of occurrences of each of the words in the database and eliminates those which fall outside of a predetermined upper and lower frequency range.

The topicality filter then compares the placement of each word within the database with the expected placement assuming the word was randomly distributed throughout the database. By expressing the ratio between a value representing the actual placement of a given word (A) and a value representing the expected placement of the word assuming random placement (E), a cutoff value may be established wherein words whose ratio A/E is above a certain predefined limit are discarded. In this manner, words which do not rise to a certain level of nonrandomness, and thus do not represent topics, are discarded.

The overlap filter then uses second order statistics to compare the remaining words to determine words whose placement in the database are highly correlated with one and another. Measures of joint distribution are calculated for word pairs remaining in the database using standard second order statistical methodologies, and for word pairs which exhibit correlation coefficients above a preset value, one of the words of the word pair is then discarded as its content is assumed to be captured by its remaining word pair member.

At the conclusion of these three filtering steps, the number of words in the database is typically reduced to approximately ten percent of the original number. In addition, the filters have discriminated and removed words which are not highly related to the topicality of the documents which contain them, or words which are redundant to words which reveal the topicality of the documents which contain them. The remaining words, which are thus highly indicative of topicality and non-redundant, are then ranked according to some predetermined criteria designed to weight them according to their inherent indicia of content. For example, they may be ranked in descending order of their frequency in the database, or according to ascending order according to their rank in the topicality filter.

The filtered words thus ranked are then cut off at either a predetermined limit or a limit generated by some parameter relevant to the database or its characteristics to create a reduced subset of the total population of filtered words. This subset is referred to as a topic set, and may be utilized as both an index and/or as a table of contents. Because the words contained in the topic set have been carefully screened to include those words which are the most representative of the contents of the documents contained within the database, the topic set allows the end user the ability to quickly surmise both the primary contents and the primary characteristics of the database.

This topic set is then utilized as rows and the filtered words are utilized as columns in a matrix wherein each of the elements of the columns and the rows are evaluated according to their conditional probability as word pairs. The resultant matrix evaluates the conditional probability of each member of the topic set being present in a document, or a predetermined segment of the database which can represent a document, given the presence of each member of the filtered word set. The resultant matrix can be manipulated to characterize documents within the database according to their context. For example, by summing the vectors of each word in a document also present in the topic set, a unique vector for each document which measures the relationships between the document and the remainder of the database across all the parameters expressed in the topic set may be generated. By comparing vectors so generated for any set of documents contained within the data set, the documents be compared for the similarity of the resultant vectors to determine the relationship between the contents of the documents. In this manner, all of the documents contained within the database may be compared to one and another based upon their content as measured across a wide spectrum of indicating words so that documents describing similar topics are correlated by their resultant vectors.

Attention is also directed to U.S. Pat. No. 6,584,220 to Lantrip et al. and to U.S. Pat. No. 6,298,174 to Lantrip et al., both of which are incorporated herein by reference. Lantrip et al. disclose, among other things, a method of determining and displaying the relative content and context of a number of related documents in a large document set. The relationships of a plurality of documents are presented in a three-dimensional landscape with the relative size and height of a peak in the three-dimensional landscape representing the relative significance of the relationship of a topic, or term, and the individual document in the document set.

Attention is also directed to U.S. patent application Ser. No. 10/602,802, filed Jun. 24, 2003, by inventors James J. Thomas et al., and entitled “Three-Dimensional Display of Document Set”, which is also incorporated herein by reference.

The system and method described in U.S. Pat. No. 6,772,170, incorporated herein by reference, and other patents, is referred to as IN-SPIRE. A predecessor to IN-SPIRE is described in the following article, which is incorporated herein by reference: Wise, J. A.; Thomas, J. J.; Pennock, K.; Lantrip, D; Pottier, M.; Schur, A., and Crow, V., “Visualizing the Non-Visual: Spatial Analysis and Interaction with Information from Text Documents”, IEEE Symposium on Information Visualization '95; Atlanta, Ga. IEEE Computer Society Press; 1995.

The concept of document vectors is also disclosed in the following article, which is incorporated herein by reference: Salton, G.; Yang, C., and Wong, A., “A Vector Space Model for Automatic Indexing”, Communications of the ACM, 1975; 18 (11):613-620.

### SUMMARY OF THE INVENTION

Aspects of the invention provide a system and method for providing visual information in response to a search request performed on a collection of documents. The visual information can be used to interpret document collections. The visual information can provide, for example, an indication of the relatedness of documents to each other and/or to certain topics that discriminate the content of the documents.

Various embodiments of the invention use a query to change document vectors, in systems and methods that use vectors to provide visual information relating to documents, to more directly reflect the contents of the query.

### BRIEF DESCRIPTION OF THE DRAWINGS

Preferred embodiments of the invention are described below with reference to the following accompanying drawings.

FIG. 1 is a table illustrating a sample query.

FIG. 2 is a screen shot of a subset view, each dot representing a document, in which collections of documents are ground around concept terms used for the query that produced the collection of documents.

FIG. 3 is a screen shot of an IN-SPIRE subset view, colored by query words that created the subset.

FIG. 4 is a screen shot showing query terms for the subsets shown in FIGS. 2 and 3.

FIG. 5 is a screen shot of a subset view, similar to FIG. 2, except shown on a different data set than in FIG. 2.

FIG. 6 is a screen shot of an IN-SPIRE subset view, using the data set of FIG. 5.

FIG. 7 is a screen shot showing query terms for the subsets shown in FIGS. 5 and 6.

FIG. 8 is a flowchart illustrating a method in accordance with various embodiments for producing the results of FIGS. 2 and 4.

FIG. 9 is a chart illustrating a matrix representing query terms.

FIG. 10 is a chart illustrating an incidence matrix of query terms for documents.

FIG. 11 illustrates a concept-based view output in accordance with alternative embodiments of the invention.

FIG. 12 illustrates superposition of information in a one-dimensional-based concept space.

FIG. 13 illustrates superposition of information in a two-dimensional concept space.

FIG. 14 illustrates how complicated activities can be represented by setting up the concept space on which information is projected.

### DETAILED DESCRIPTION OF THE PREFERRED EMBODIMENTS

Various embodiments disclosed herein are embodied in a memory bearing computer readable code loadable in a programmable computer or transmittable over a network such as the Internet (e.g., embodied in a carrier wave). The memory can be any sort of RAM or ROM such as a floppy disk, EPROM, CD-ROM, CD-RW, hard drive, optical drive, etc. The particular programming language selected is not critical, any language which will accomplish the required instructions necessary to practice the method is suitable. Similarly, the particular computer platform selected for running the code which performs the series of instructions is not critical. Any computer platform with sufficient system resources such as memory to run the resultant program is suitable, such as a Sun Sparc system, a Silicon Graphics Workstation, a personal computer, a networked environment, a mainframe, etc. The database that is to be interrogated includes a series of documents written in some natural language. While the natural language could be English, the methodology will work for any language. The documents are converted into an electronic form to be loaded into the database. This may be accomplished by a variety of methods, including scanning and using optical character recognition on documents that are not already in a text or word processor document format.

Various steps included in U.S. Pat. No. 6,772,170 to Pennock et al. are used in embodiments of the invention. Aspects of U.S. Pat. No. 6,772,170 will first be discussed, then modifications to it will be disclosed.

U.S. Pat. No. 6,772,170 discloses, in a first step, examining individual words contained in a database to create a filtered word set. The filtered word set is produced by sending the database through a series of three filters, the frequency filter, the topicality filter and the overlap filter. The filtered word set is then further reduced to produce a topic set.

Frequency Filter

The frequency filter first measures the absolute number of occurrences of each of the words in the database and eliminates those which, for example, fall outside of a predetermined upper and lower frequency range.

Topicality Filter

The remaining words are then sent through a topicality filter which compares the placement of each word within the database with the expected placement assuming the word was randomly distributed throughout the database. The approach followed in various embodiments for topic filtering is based on the serial clustering work described in “Detecting Content-Bearing Words by Serial Clustering”, Bookstein, A., Klein, S. T., Raita, T. (1995) Proceedings of the 15th Annual International ACM SIGIR Conference on Research and Development in Information Retrieval, pp. 319-327, and incorporated herein by reference. The method greatly simplifies the serial clustering as described in Bookstein et al by approximating the size of the text unit with the average size of the document, and then assuming uniform distribution of each word within the document so that word counts in documents which are larger than average are scaled down and word counts in documents which are smaller than average are scaled up. For example, the count for a particular word for a document which contains m times the average number of total words, and a count n of a particular word, is scaled by a factor of 1/m. This approximation avoids the computationally expensive text unit divisions identified in Bookstein et al.

The concept can be understood by considering the placement of points within a grid of cells. Given m points randomly distributed on n cells, some cells can be expected to contain zero points, others one, etc. Numerically, condensation clustering is the ratio between the actual number of occurrences of a term within a text unit (document or subdocument unit) of arbitrary size, to the expected number of occurrences, and is given by:

Condensation Clustering Value=A(tₐ)/E(tₐ)

with

tₐ=a token

E(tₐ)=U[1−(1−1/U)^{T}]

and with

U=# documents in the corpus, and

T=# occurrences of token tₐ in the database.

Thus, topic words are characterized by their condensation clustering value. In some embodiments, words having a condensation clustering value of less than a predetermined value are selected for inclusion in the filtered word set.

Overlap Filter

In some embodiments, the remaining words are then sent through the overlap filter. The overlap filter uses second order statistics to compare the remaining words to determine words whose placement in the database are highly correlated with one and another. Many measures of joint distribution are known to those skilled in the art, and each is suitable for determining values which are then used by the overlap filter. In some embodiments, conditional probabilities are utilized to represent the relationship between words, so that the relationship between term aᵢ and term bⱼ is given by:

P(tⱼ/tᵢ)=the conditional probability of tᵢ given tⱼ

Word pairs which are closely correlated may have one of their members discarded as only the remaining member is necessary to signify the content of the word pair. Thus, for word pairs having a correlation above a preset value, 0.4 for the preferred embodiment, the overlap filter will discard the lower topicality word of the pair, as its content is assumed to be captured by its remaining word pair member.

After the overlap filter has eliminated redundant words, the final set of filtered words is complete. In some embodiments, these filtered words are ranked in descending order according to their frequency in the database.

Topic Set

The words with a topicality value below a predefined threshold, are then selected to define a topic set or list. The words that define the filtered word set and/or the topic set be displayed to the user as they are extremely useful in and of themselves for communicating the general content of the database or dataset. In short, at this juncture, a listing of key terms is available which are readily interpreted by humans and which are highly representative of the underlying topicality of the dataset.

This topic set is then utilized as rows and the filtered words are utilized as columns in a matrix wherein each of the elements of the columns and the rows are evaluated according to their conditional probability as word pairs. The matrix is described as two sets of words: the topic words (i) and the filtered words, or (j). An i by j matrix is then computed, with the entries in the matrix being the conditional probabilities of occupance, modified by the independent probability of occurrence, or

Mᵢⱼ=P(tⱼ/tᵢ)−Beta*P(tⱼ)

with

Mᵢⱼ=the ith row, jth column of the conditional probability matrix

P(tⱼ/tᵢ)=the conditional probability of tᵢ given tⱼ

P(tⱼ)=the probability of tⱼ

Beta=parameter constant to ensure strong correlations

Document Vectors

A vector space model is then used for content characterization. To measure the degree of match between documents and a query, the vector space model can be very efficient. For natural language-based queries or extended Boolean queries, the vector-space model allows documents to be ranked from top to bottom using a dot product. Queries, in this model, are vectors in the vector space, the same as any unit of text (from a single word to a document or even multiple documents). The vector space model also provides a spatial representation for information. The representation conveys significant structural information which is important to many operations such as grouping or clustering or projecting.

In some embodiments, topics words serve as dimensions in the vector-space model. Given that the major topics of a data set have been defined using the described filtering techniques, and that the vocabulary of the data set has been probabilistically linked to the topics, the general goal of document content characterization is to map the specific document contents to varying values for each of the topics in the canonical set. Just as functions can be defined by combinations of sinusoids, documents are defined by combinations of topic values. The contents of each document are then judged strongly related to those topics for which relatively large values are calculated. Topics of interest can easily be enhanced or diminished through linear transforms on the topic magnitudes across the document set. This permits users to define spatial relationships among documents based on their interests, instead of a single predefined representation. The limitless combinations of topics and values thus allow a rich method of content characterization in the preferred embodiment.

The construction of the document vectors proceeds as follows, in various embodiments. For each document in the data set, the following steps are followed to produce a vector:

1) words of interest are determined (the topic words contained in the document)

2) a vector for each word of interest in the document is extracted from the modified conditional probability matrix (e.g. if the first word of interest is entry n in the conditional probability matrix, the corresponding vector is the nth column of the matrix, with each row of that vector the modified conditional probability associating the word of interest with each topic)

3) the vectors for each word of interest are summed, and

4) the final vector summation is normalized so that the summation of all component magnitudes is one.

Document Steering

In current approaches to evaluating text corpora, algorithms often select words (and cluster and summarize the data in terms of these topics) that bear little resemblance to the expected subject under investigation, particularly when these subjects are revealed within queries. Because the existing systems and methods seek to discriminate the documents in the collection rather than describe the documents, clustering and labeling sometimes do not completely meet the expectations of analysts (users of the system). Therefore, various improvements are provided herein. Various embodiments of the invention use a query to change document vectors to more directly reflect the contents of the query. Clustering is described, for example, in U.S. Pat. No. 6,574,632 to Fox, which is incorporated herein by reference.

In various embodiments, the discovery of actionable information is improved by enabling the analyst to steer the analysis of large volumes of textual information while remaining aware of the change in the information. Steering is accomplished, in some embodiments, by identifying what is most relevant (particularly when those things are not identified or given weight within the corpus itself), based, for example, on an analyst's profile, tasking, and other considerations. Such steering, in some embodiments, introduces both the analyst's domain knowledge and the analysis objectives into the analysis of the text data at hand. The steering may benefit the harvesting, classification, clustering, and projection of topics, concepts, and documents within the concepts, as well as their labeling.

Various embodiments improve the discovery of actionable information by enabling an analyst to steer the analysis of large volumes of textual information while remaining aware of the change in the information. Steering is accomplished by identifying what is most relevant (e.g., when those things are not identified or given weight within the corpus itself), based on an analyst's profile, tasking, etc. Such steering is intended to introduce both the analyst's domain knowledge and the analysis objectives into the analysis of the text data at hand. The steering may benefit the harvesting, classification, clustering, and projection of topics, concepts, and documents within the concepts, and their labeling.

The amount of available potential information, even just that information residing in well organized data stores, continues to grow. There is a continuing, pressing need to improve the information retrieval, sifting and focus that are readily available to the information analyst. Various embodiments will be disclosed that can be readily integrated with current working analysis procedures.

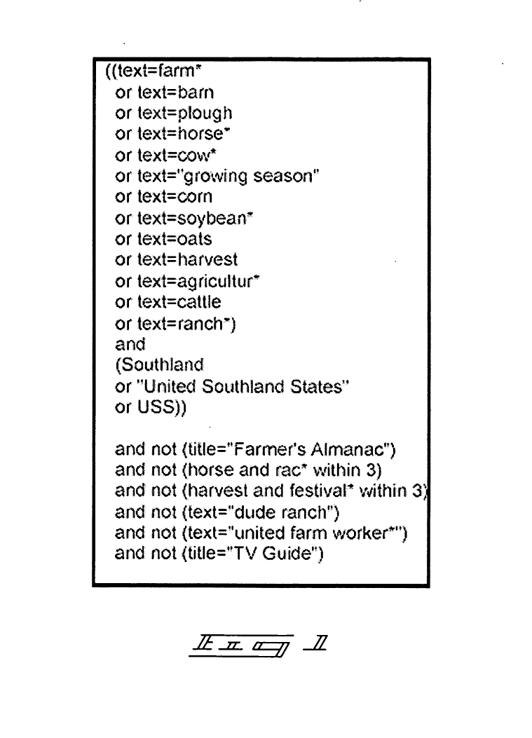

Current retrieval methods employ well crafted queries to direct document retrieval. These queries evolve with the user's expertise and focus areas. FIG. 1 shows a simple example.

The guidance indicated in FIG. 1 is more than the query—there is some broad relatedness of the concepts that appear in the “or” and some detailed guidance about the types of information to exclude. This, and similar information provided by the analysts, can be brought to bear to increase the effectiveness of both document retrieval and analysis. Methodology relating to this particular workflow will now be described.

Analyses in the Query Workflow

Various embodiments provide a summarization method and apparatus that incorporates the analysts' inputs, as expressed in the query that generates the document collection under investigation.

The general broad workflow that contributes to meeting the above needs is as follows:

1. Initial query construction—Select topics of interest, in the form of a query, similar in form to that in FIG. 1. Queries may vary in complexity from simple statements containing just a couple of terms, to pages of complex Boolean logic.

2. Query generalization—automatic assistance is provided for augmenting the contents of the initial query.

3. Retrieval and Analysis—The generalized query is applied. The documents retrieved are summarized, and an analytic framework for rapidly refining the document set and understanding the contents is employed.

4. Refinement—The user/analyst can refine the query results by tagging some documents as “relevant” or “not-relevant”, and then re-applying the query either to the batch of documents at hand or to a larger set from which the docs were drawn.

5. Feedback to an editable query—the information provided based on the generalization and refinement steps are fed back to create a query that codifies that information for subsequent use on new or updated document collections.

In various embodiments, user guidance is incorporated, as expressed in the query that yielded the documents, into a labeled summary organization (visual representation) of the document collection.

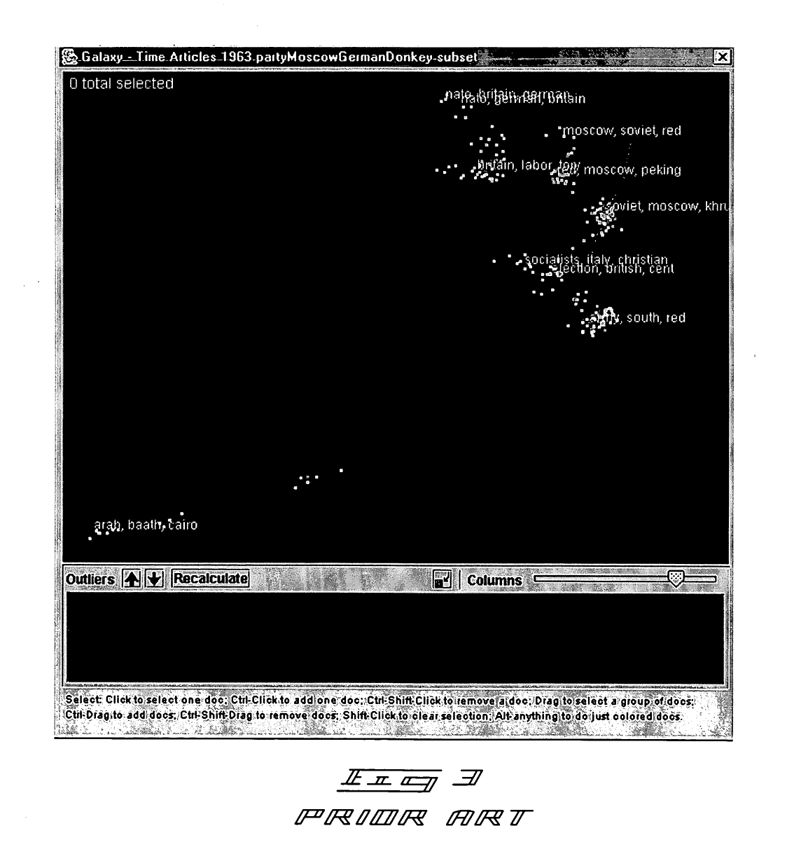

Applicants' IN-SPIRE system, or other embodiments, processes a collection of documents in a way that eventually results in a numeric vector being created in association with each document. Vectors are also used in other methods, such as the one described in the Salton, Yang, and Wong article mentioned in the Background of the Invention section. Embodiments of the invention may have application to any system and method for visually indicating characteristics of documents using vectors. The vectors, variously referred to as context vectors or document vectors, are, in various embodiments, all the same dimension and suitable for a variety of data analyst activities. The coordinates of the vectors correspond with “topic words”. In various embodiments, the term “topic words” refer to strings that occur non-randomly in the document collection (see, for example, Bookstein, A., “Relevance”, Journal of the American Society for Information Science, 1979; 30:269-273). Applicants' IN-SPIRE processes the vectors using clustering, projection (to obtain the layout shown in FIG. 3) and feature extraction (to obtain the labeling shown in FIG. 3).

The challenge associated with queries is well illustrated in FIG. 3. The query terms used to create the subset under investigation are displayed in FIG. 3 and are not the same as the query terms of FIG. 1.

Various new embodiments use the following steps:

Step 1. Represent the query contents as an indicator matrix. The query is broken down into “atomic” terms. For example, the query shown in FIG. 1 contains the following as atomic terms: farm, barn, plough . . . Then, a matrix is constructed that indicates which document contains which atomic term.

Step 2. Force the atomic query terms to be classified as “topic words” by increasing the topicality value associated with the terms.

Step 3. Rotate the document vectors to match the indicator matrix using canonical correlations. Canonical correlations are known in the art and are described, for example, in: Seber, G. A. F. Multivariate Observations, New York:, John Wiley & Sons; 1984. This algorithm is applied to the matrix of document vectors from IN-SPIRE, and an incidence matrix from the query terms. The rotated document vectors then become the vectors that are clustered and projected to create a “summary view.”

The canonical correlation procedure is an intrinsically different vector and projection procedure from that currently used in IN-SPIRE. The inputs are different; the method and apparatus described herein uses information related to the query to construct the summary view, and the current IN-SPIRE summary method does not.

The canonical correlations procedure finds the rotations by solving a sequence of optimization problems. Letting x denote the matrix of document vectors and y denote the incidence matrix, the rotation vectors are found by solving the optimization problem:
max_{α,β}(correlation (α^{t}×β^{t} y))

After initial rotations α¹ and β¹ are found, the same optimization problem is solved, with the constraint that subsequent α's and β's are to be orthogonal to those found so far. A limit in the number of rotation vectors α that can be found is the minimum number of columns in x and y. So, if very few atomic terms are used to construct the query, the vectors that are passed on to IN-SPIRE for processing have small dimension.

Note that if a single word is found for the query, the additional dimension needed to arrive at a two-dimensional projection should be added from some other source (e.g. principle components).

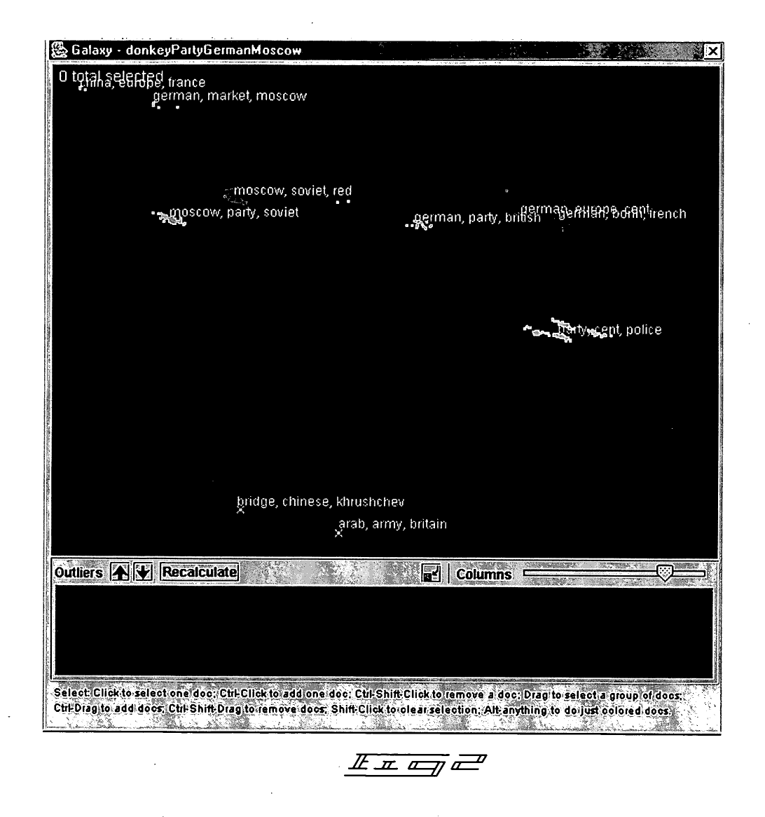

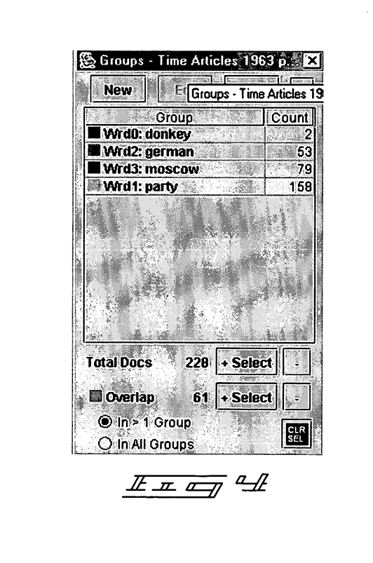

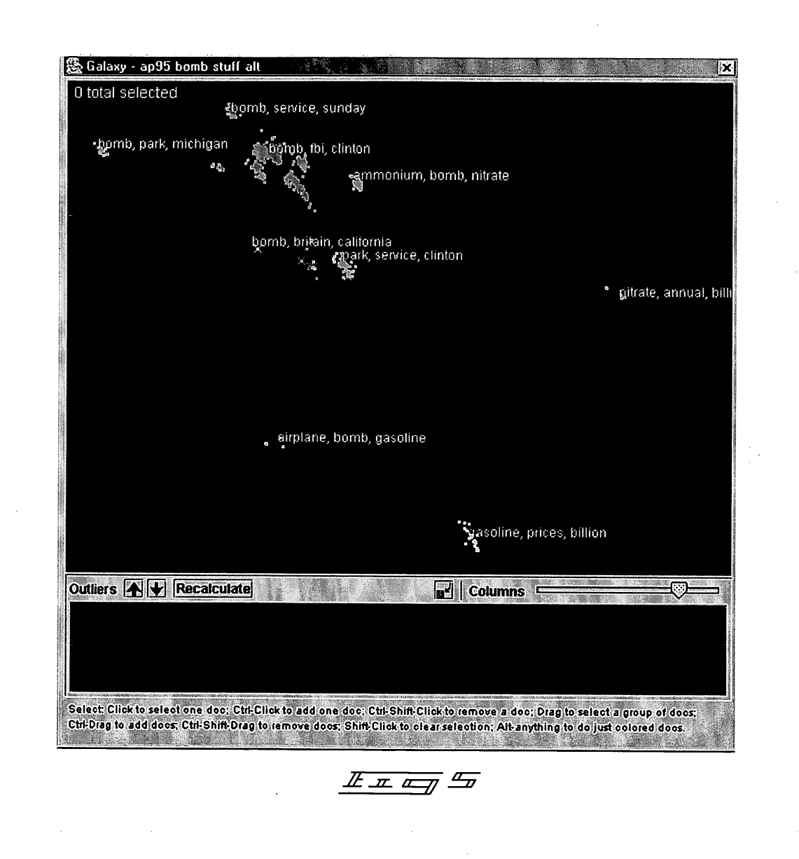

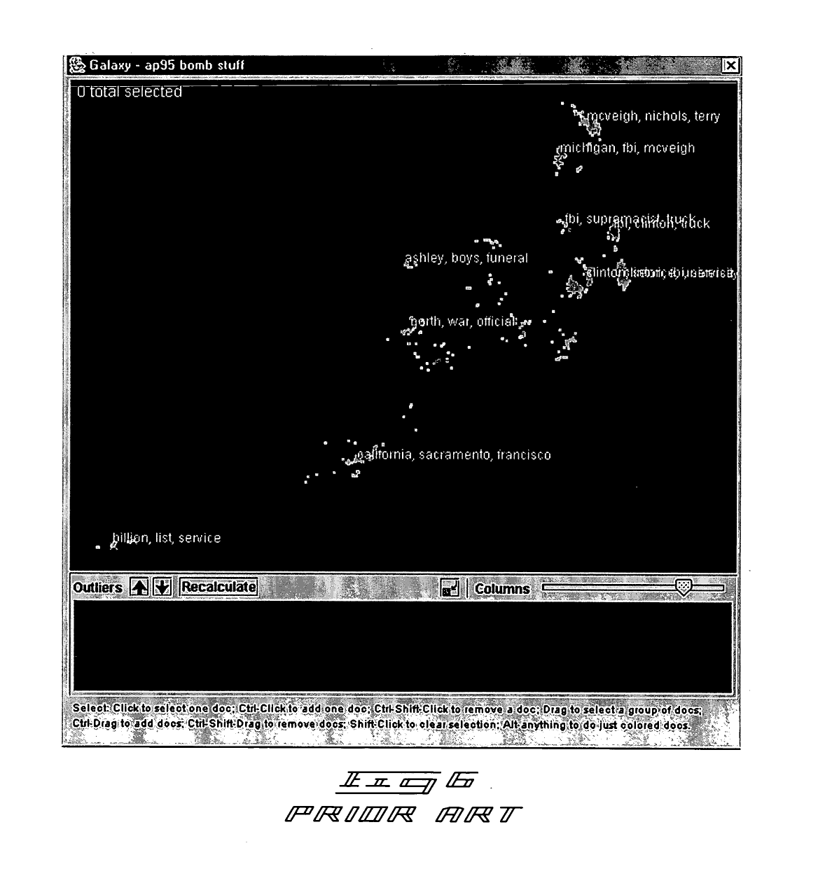

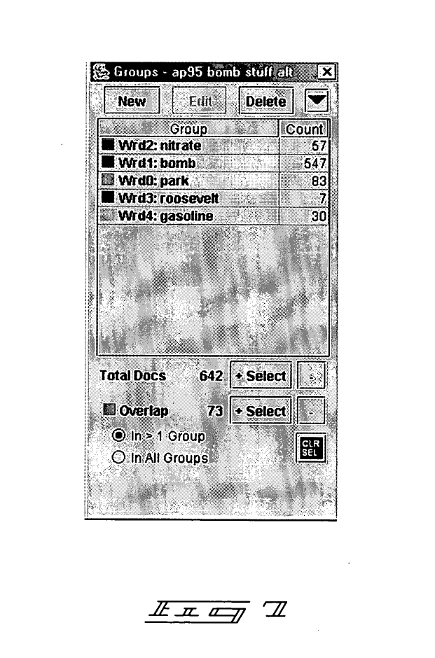

FIGS. 2-4 and FIGS. 5-7 each show the result from the new system and method. The result from the current method and apparatus is also shown. FIG. 2 shows the results from the new method and apparatus algorithm; FIG. 3 the results from the current method and apparatus. FIG. 5 shows the results from the new method and apparatus algorithm; FIG. 6 the results from current method and apparatus. FIGS. 5-6 use a different data set than FIGS. 2-3. More particularly, FIG. 4 is a screen shot showing query terms for the subsets shown in FIGS. 2 and 3, and FIG. 7 is a screen shot showing query terms for the subsets shown in FIGS. 5 and 6.

The coloring of the points in the figures corresponds with the presence of the atomic query terms used to construct the subsets.

The visual clustering in FIG. 2 is more consistent with the query terms. The adjusted clusterings are “tighter” than the standard IN-SPIRE clusterings. The labels tend to involve the query terms somewhat more—due to the increase in topicality values for query terms.

In some embodiments, a representation of the query that is closer to that crafted by the analyst is constructed from the Boolean components of the query; for example (barn or plough). An incidence matrix is made from these components, and labels are constructed based on the queries, in some embodiments.

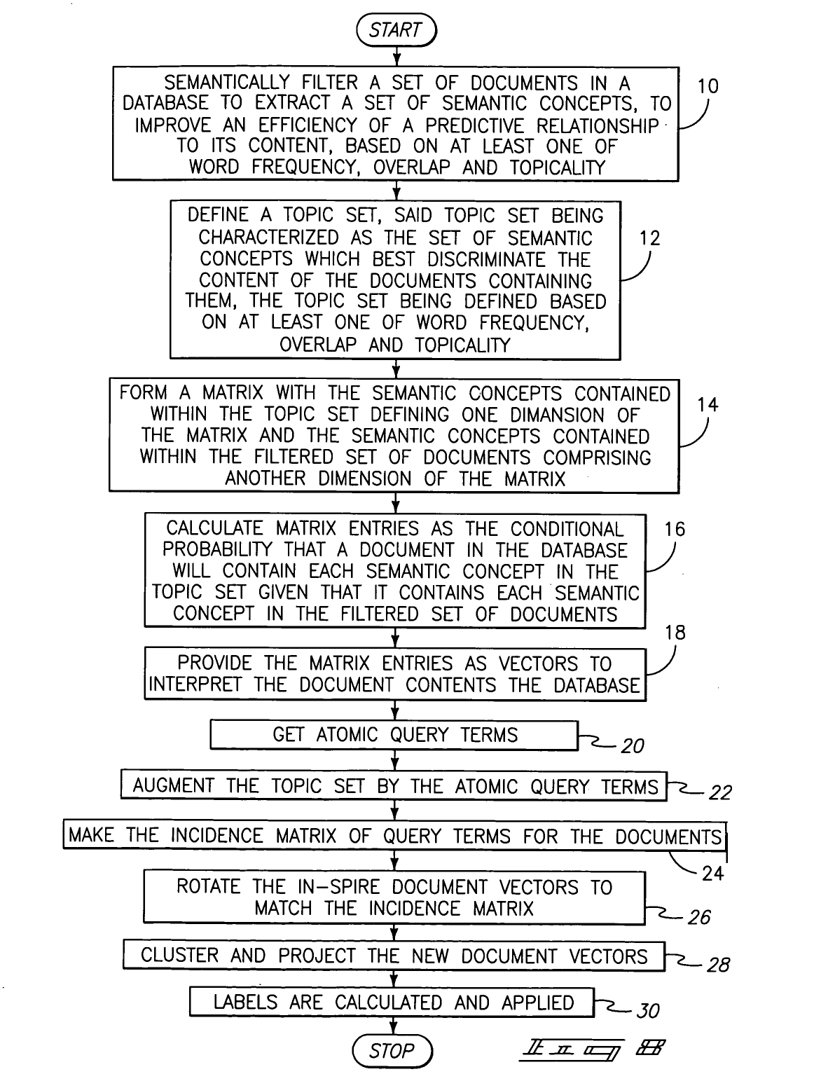

FIG. 8 is a flowchart illustrating a method, in accordance with various embodiments, for producing the results of FIGS. 2 and 4. The method of FIG. 8 is embodied in computer program code, in some embodiments. The computer program code can be embodied in any memory or carried by a carrier wave (e.g., transmitted over the Internet or some other network). The computer program code can be embodied in a media such as a RAM, or ROM, a processor, an ASIC, an EPROM, as a floppy disk, hard drive, CD-ROM, DVD-ROM, memory card or stick, or any other media capable of bearing computer program code. The program code can be run on a computer as described above at the beginning of the Detailed Description.

More particularly, FIG. 8 outlines a calculation of a document projection that takes account of user query input. In some embodiments, this calculation is embedded in the IN-SPIRE software. The information is intended to indicate the changes in the IN-SPIRE processing that will be needed and to provide sufficient details to support the design and implementation of the changes. The sequence of steps shown in FIG. 8 can be changed or reordered as will be apparent to those of ordinary skill in the art, or steps can be combined or reduced or increased, if desired.

In step 10, in some embodiments, a set of documents in a database is semantically filtered to extract a set of semantic concepts, to improve an efficiency of a predictive relationship to its content, based on at least one of word frequency, overlap and topicality. In some embodiments, all three filters are used, as disclosed in U.S. Pat. No. 6,772,170, incorporated herein by reference. In alternative embodiments, less than three filters are used.

In step 12, a topic set is defined. The topic set is characterized as the set of semantic concepts which best discriminate the content of the documents containing them, the topic set being defined based on at least one of word frequency, overlap and topicality.

In step 14, a matrix is formed with the semantic concepts contained within the topic set defining one dimension of the matrix and the semantic concepts contained within the filtered set of documents comprising another dimension of the matrix.

In step 16, matrix entries are calculated as the conditional probability that a document in the database will contain each semantic concept in the topic set given that it contains each semantic concept in the filtered set of documents.

In step 18, the matrix entries are provided as vectors (to be displayed on a monitor) to interpret the document contents of the database.

In step 20, atomic query terms are obtained. Query terms are replaced with atomic query terms. For example, if the query is nixon or (china and duck and peking) or Cambodia or (pardon and (not my) and duck*), then the atomic terms would be Nixon, china, duck*, peking, Cambodia, pardon, my. duck* would be replaced by a list of all the words in the corpus that the regular expression matches. For the purposes of this discussion, suppose that the words that match are: duck, ducks, ducking, and duckboard. This makes a total of 10 atomic terms from this query.

In step 22, the topic set or list is augmented by the atomic query terms. They are just forced in, e.g., added to the top 200 (or whatever) to make a longer vector. The document vector calculation proceeds from there as before.

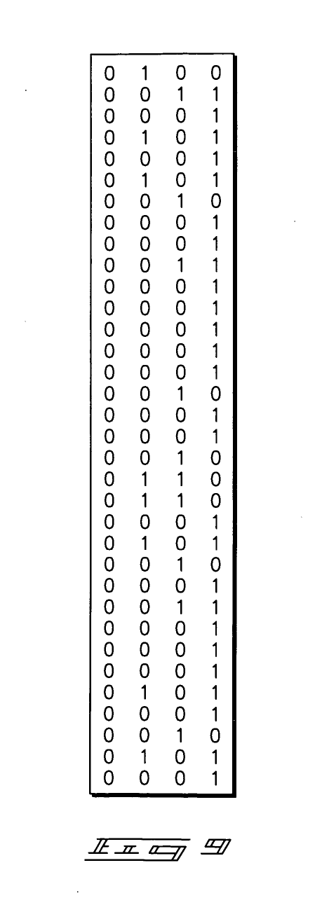

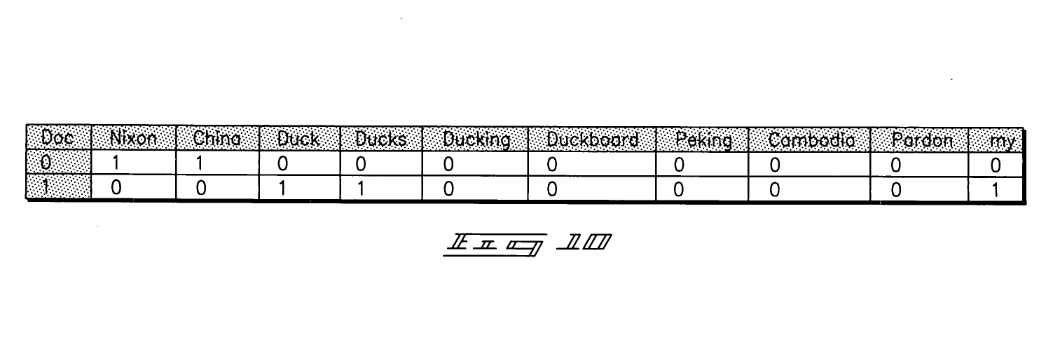

In step 24, an incidence matrix of query terms for the documents is made. FIG. 9 shows such a matrix for a query that has four atomic terms (hence the four columns). Each row corresponds to a document, each column with an atomic term. The individual entries are 1 or 0, depending on whether the term is in the document. For instance, the first document (corresponding to the first row) contains the second term and none of the other terms of the 4 atomic terms. For example, if there are 567 documents, and (as in our working example), and doc 0 contains “nixon and “china”; but no other words, and doc 1 contains “duck”, “ducks” and “my”; but no other of the atomic query words; then the first two rows of the 567×10 incidence matrix would be as shown in FIG. 10. Note that the first row and first column of FIG. 10 are just in place for labeling; the actual matrix need not directly incorporate the labels.

In step 26, the IN-SPIRE document vectors are rotated to match the incidence matrix. In some embodiments, the rotation is accomplished using a standard, known procedure called canonical correlations (Seber 1984). The canonical correlations procedure calculates a rotation between two matrices to “match” them up. Consequently, the inputs to the procedure will be the matrix of document vectors (the dimension can be something like 567×210, for example) and the incidence matrix (dimension 567×10, for example). The output is the matrix of rotated document vectors; this matrix will have the same as the input incidence matrix, e.g., dimension 567×10. Due to the potential for reduced rank matrices, the dimension may sometimes be smaller.

In step 28, the new document vectors are clustered and projected. At the beginning of this step, a rotated document vector matrix is available, e.g., of dimension 567×10. The intent is to cluster/project these in place of the actual document vectors, using the existing cluster/project steps of IN-SPIRE, in some embodiments.

In step 30, labels are calculated and applied. IN-SPIRE default labeling is used in some embodiments. A display is generated to be shown on a computer monitor or to be printed.

Concept-Based Projections.

A different embodiment of the invention will now be described. The inventors believe that a concept-based view can provide various advantages, such as to help:

Rapidly and accurately update the information representation provided to the user/analyst with new information, as the new information becomes available.

Provide the infrastructure so that information objects can be set aside to improve the focus of the data objects under consideration—This activity would be driven by the analyst.

Incorporate user/analyst perspectives into the information representations.

The intent of a concept-based view will first be described, followed by a discussion of how the objectives can be met using that technology.

The fundamental approach described is a topic/concept projection onto which documents are “smeared”. FIGS. 8 and 9 show a one-dimensional version; a two-dimensional version is shown in FIG. 10. Features of various embodiments of a concept-based view can include the following:

Each concept occurs at a single location in the view. The concepts are the labels for the coordinates for the view.

Documents (or more general data objects) are shown across multiple locations on the view, depending on which concepts they contain or indicate.

Given flexibility on just what constitutes a concept, and on the arrangement of concepts, a wide variety of useful analytic tools can be constructed, and the objectives can be addressed.

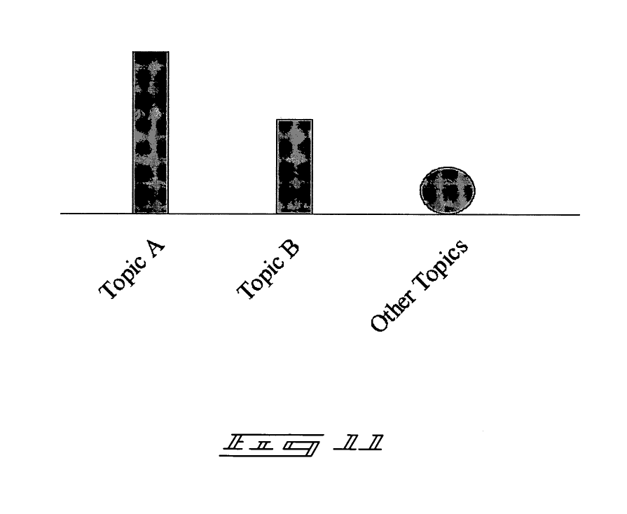

FIG. 11 is a simple concept-based view showing two distinct concepts and a generic concept bucket onto which some number of documents have been projected. The interpretation is analogous with a “ThemeView” in IN-SPIRE; the higher bar for “Topic A” indicates that the collection is more about “Topic A” than it is about “Topic B”. The “Other Topics” glyph is drawn with some other indicator; e.g., something other than a bar, to indicate the possibility for showing that there are some topics without being overly specific about their weight within the collection. That is, the “Other Topics” area serves as a dumpster/bin/long-term-storage area for topics; it provides a mechanism with which to address the need to have a “place” to set-aside information-bearing objects that are not directly relevant to the analyst's current focus. Instead of using bars for Topic “A” and Topic “B,” alternative indicators could be used as will be appreciated by one of skill in the charting or graphing arts.

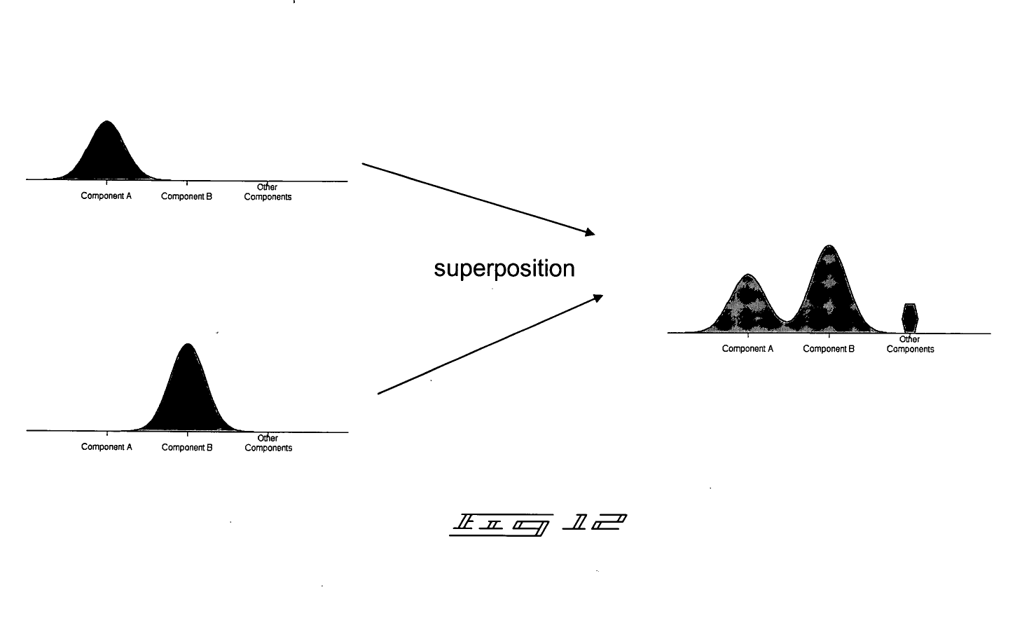

FIG. 12 indicates, in the context of a simple concept space similar to the “two-concept” space of FIG. 11, how multiple information objects are presented in a concept space, in some embodiments. The concept values for each of the information objects are combined to yield the summary view for the pair. The additive behavior is mathematically similar to superposition, which is used to describe a variety of phenomena related to spectroscopy and electro-magnetic energy. Note that an extremely large number of information objects can be summarized in such a concept space. The computational complexity of the projection is primarily the cost of evaluating the each information object against the concept-space of interest; such a calculation is parallelized, in some embodiments.

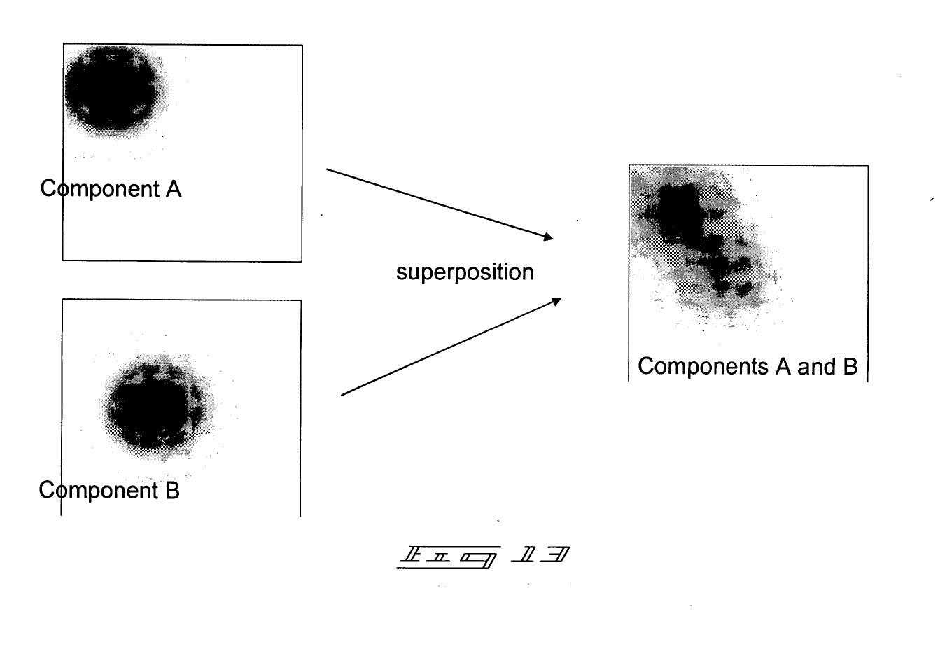

FIG. 13 exhibits an analogous procedure and visualization; but with a two-dimensional layout of concept space. The same comments regarding computational complexity apply; the output can be obtained with extremely rapid calculation. FIG. 13 shows a superposition of information in a two-dimensional concept space. Note the visual similarity with IN-SPIRE's Theme View.

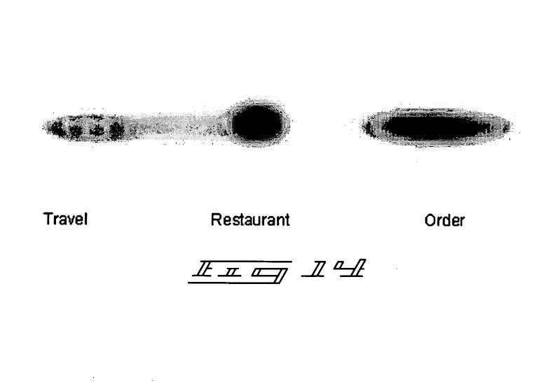

FIG. 14 is an example of a display indicating how more complicated activities, such as going to a restaurant, can be represented by setting up the concept space on which information is “projected”.

FIG. 14 indicates a specific concept space set up to focus on a particular analytic activity, in accordance with some embodiments. For instance, if the analyst is attempting to detect eating out, then a concept space that includes the concepts of “Travel”, “Restaurant” and “Ordering a Meal” would be relevant. Information objects are sifted through to detect these concepts and, finally, a display like FIG. 14 is constructed (and, for example, is displayed on a monitor or is printed out) to indicate whether the activity has occurred. An analyst can construct a space like that in FIG. 14 by hand, based on the analytic objectives. Data objects are analyzed more automatically to determine whether there is evidence that the particular activity or scenario has occurred.

The interpretation of the display in FIG. 14 is similar to that of FIGS. 11 through 13, so there is some mention of “Travel” in the collection and stronger indications of “Restaurant” and “Ordering a Meal”. Additional visual dimensions are open for interpretation-the shape of the concentration and the “smear” between concepts. For instance, the shape might be used to indicate certainty and the smearing to indicate connectedness between evidence.

The underlying mathematical representation that supports such a visual representation includes:

1) A list of topics or concepts; note that these need not be restricted to text-strings that occur in the documents. Abstractly, these are a list of functionals that can be applied to documents. The examples above are consistent with functionals always returning a non-negative value. Returning “0” means that the document does not involve that topic, and larger magnitudes mean that the document has “more” to do with that topic/functional.

2) The numeric value of the functionalltopic for each document.

With these structures, the representations and interactions described above can be carried out. Note that simple versions of these structures are currently available (e.g. concepts as text strings; concepts as objects obtained via existing entity extraction tools).

Thus, a concept based view has been provided that can be updated via superposition of new information onto the existing concept substrate—this feature is illustrated in FIGS. 11 through 13.

The objects that are viewed on the substrate can be selected by the analysts—this feature was discussed in the context of FIG. 14.

The substrate can be edited to reflect the analyst's perspectives and the problem/task at hand—this feature was discussed in the context of FIG. 14.

In some embodiments, a concept-based view of an information collection can be constructed to scale to large (millions of documents) data sets—this is supported by the “update” or “incremental” calculation nature of superposition.

In some embodiments, a concept-based view of an information collection can be constructed as a usable summary of a document collection.

In summary, two approaches to steering have been provided. The first approach can be connected with existing analysts' workflow and existing analytic technology such as IN-SPIRE. A method and apparatus are provided for incorporating analysts' guidance and steering, as expressed by the query used to retrieve the information objects, into the resulting summary view.

The second approach is based on representing information objects in a concept-space setting; essentially changing the fundamental way in which information objects are summarized.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method of steering the analysis of a collection of documents, comprising:
receiving query terms for use in querying a database including a collection of documents;
representing at least some of the query terms in a matrix;
rotating document vectors associated with the documents to match the matrix to produce a matrix of rotated document vectors, each document vector representing a numeric vector created in association with individual documents;
grouping the rotated document vectors into clusters, each cluster having one or more documents; and
projecting the clusters to display visual information of the documents, the visual information including a summary view of the collection of documents.

2. The method of claim 1, further comprising labeling the clusters using labels representing contents of the query.

3. The method of claim 1, wherein representing contents of the query comprises:
separating the query into atomic terms, the atomic terms including query terms for retrieving the collection of documents; and
constructing the matrix with the atomic terms.

4. The method of claim 3, wherein the matrix comprises an incidence matrix.

5. The method of claim 3, further comprising classifying the atomic terms as topic words by increasing a topicality value associated with the respective atomic terms.

6. The method of claim 1, wherein rotating the document vectors comprises changing the document vectors to reflect contents of the query.

7. The method of claim 1, wherein rotating the document vectors comprises rotating the document vectors using canonical correlations.

8. The method of claim 1, wherein grouping the rotated document vectors comprises grouping the rotated document vectors based on contents of the query.

9. The method of claim 1, wherein grouping the rotated document vectors is not based solely on contents of documents retrieved by the query.

10. The method of claim 1, wherein grouping the rotated document vectors comprises grouping documents associated with the rotated document vectors using statistical determination.

11. The method of claim 1, wherein grouping the rotated document vectors comprises grouping documents associated with the rotated document vectors into an unsupervised classification using a statistical technique.

12. The method of claim 1, wherein displaying visual information comprises displaying a summary view of the documents.

13. The method of claim 12, wherein the summary view is created based on contents of the documents projected into the clusters as well as on the contents of the query used to produce the clusters.

14. The method of claim 1, wherein the clusters comprise a collection of documents, the clusters being consistent with the contents of the query used to produce the clusters.

15. A method of steering the analysis of a collection of documents, comprising:
receiving a query against a database;
obtaining a query result set having a collection of documents;
grouping the collection of documents into a classification to produce a plurality of clusters, each cluster having a set of documents from the collection of documents, the grouping of the collection of documents into the clusters being based on contents of the query; and
displaying the clusters to display visual information of the collection of documents.

16. The method of claim 15, further comprising labeling the clusters using labels representing contents of the query.

17. The method of claim 15, the grouping comprises:
representing contents of the query as an incidence matrix, the incidence matrix comprising keywords of the query for retrieving the collection of documents;
rotating document vectors associated with the documents to match the incidence matrix, each document vector representing a numeric vector created in association with individual documents;
producing a matrix of rotated document vectors; and
classifying the rotated document vectors to produce the plurality of clusters.

18. The method of claim 17, wherein the rotating comprises changing the document vectors to reflect contents of the query.

19. The method of claim 17, wherein the rotating comprises rotating the document vectors using canonical correlations.

20. The method of claim 17, wherein the grouping further comprises:
separating the query into atomic terms;
constructing the incidence matrix using the atomic terms; and
classifying the atomic terms as topic words by increasing a topicality value associated with the respective atomic terms.

21. The method of claim 17, wherein the grouping further comprises grouping documents associated with the rotated document vectors using statistical determination.

22. The method of claim 17, wherein the grouping is not based solely on contents of documents retrieved by the query.

23. The method of claim 15, wherein display of visual information comprises displaying a summary view of the collection of documents.

24. The method of claim 23, wherein the summary view is created based on contents of the collection of documents projected into the clusters as well as on the contents of the query used to produce the clusters.

25. The method of claim 15, wherein the clusters comprising the collection of documents is consistent with contents of the query used to produce the clusters.

26. A computer-readable medium comprising computer program code which, when loaded in a computer, causes the computer, in operation, to:
receive a query against a database;
obtain a query result set having a collection of documents;
group the collection of documents into a classification to produce a plurality of clusters, each cluster having a set of documents from the collection of documents, the grouping of the collection of documents into the clusters being based on contents of the query; and
display the clusters to display visual information of the collection of documents.

27. The computer readable medium of claim 26, wherein the computer program code is further configured to label the clusters using labels representing contents of the query.

28. The computer readable medium of claim 26, wherein grouping the collection documents comprises:
representing contents of the query as an incidence matrix, the incidence matrix comprising keywords of the query for retrieving the collection of documents;
rotating document vectors associated with the documents to match the incidence matrix, each document vector representing a numeric vector created in association with individual documents;
producing a matrix of rotated document vectors; and
classifying the rotated document vectors to produce the plurality of clusters.

29. The computer readable medium of claim 27, wherein rotating the document vectors comprises changing the document vectors to reflect contents of the query.

30. The computer readable medium of claim 27, wherein rotating the document vectors comprises rotating the document vectors using canonical correlations.

31. The computer readable medium of claim 27, wherein grouping the collection of documents further comprises:
separating the query into atomic terms;
constructing the incidence matrix using the atomic terms; and
classifying the atomic terms as topic words by increasing a topicality value associated with the respective atomic terms.

32. The computer readable medium of claim 27, wherein grouping the collection of documents further comprises grouping documents associated with the rotated document vectors using statistical determination.

33. The computer readable medium of claim 27, wherein grouping the collection of documents is not based solely on contents of documents retrieved by the query.

34. The computer readable medium of claim 26, wherein display of visual information comprises displaying a summary view of the collection of documents.

35. The computer readable medium of claim 34, wherein the summary view is created based on contents of the collection of documents projected into the clusters as well as on the contents of the query used to produce the clusters.

36. The computer readable medium of claim 26, wherein the clusters comprising the collection of documents is consistent with contents of the query used to produce the clusters.

37. An information analysis and steering method, comprising:
receiving an information collection including information objects, each information object having a descriptive vector;
associating the information object with an indicator vector, the indicator vector having a plurality of vector coordinates;
labeling each of the plurality of vector coordinates with contents of a query that is used to produce the information collection; and
projecting the information collection as clusters, the clusters including the descriptive vectors and contents of the indicator vectors.

38. The method of claim 37, wherein the associating comprises representing the contents of the query as an incidence matrix.

39. The method claim 38, wherein the incidence matrix is generated by separating the query into atomic terms, and arranging the atomic terms in the form of a matrix.

40. The method of claim 39, wherein the associating further comprises:
rotating descriptive vectors associated with the information objects to match the incidence matrix to produce a matrix of rotated descriptive vectors; and
grouping the rotated descriptive vectors into the clusters.

41. The method of claim 40, wherein the labeling comprises labeling the clusters based on contents of the query.

42. The method of claim 40, wherein the rotating comprises rotating the descriptive vectors using canonical correlations.

43. The method of claim 40, wherein the grouping comprises grouping the clusters into an unsupervised classification using statistical determination.

44. The method of claim 37, wherein projecting the information collection as clusters comprises displaying a summary view of the information collection, the summary view being created based on the information collection projected as the clusters as well as on the contents of a query used to produce the information collection.

45. An information analysis and steering system comprising a computer server configured to:
receive an information collection including information objects, each information object having a descriptive vector;
associate the information object with an indicator vector, the indicator vector having a plurality of vector coordinates;
label each of the plurality of vector coordinates with contents of a query that is used to produce the information collection; and
project the information collection as clusters, the clusters including the descriptive vectors and contents of the indicator vectors.

46. The system of claim 45, wherein associating the information object comprises representing the contents of the query as an incidence matrix.

47. The system of claim 46, wherein the incidence matrix is generated by separating the query into atomic terms, and arranging the atomic terms in the form of a matrix.

48. The system of claim 47, wherein associating the information object further comprises:
rotating descriptive vectors associated with the information objects to match the incidence matrix to produce a matrix of rotated descriptive vectors; and
grouping the rotated descriptive vectors into the clusters.

49. The system of claim 48, wherein labeling each of the plurality of vector coordinates comprises labeling the clusters based on contents of the query.

50. The system of claim 48, wherein rotating the descriptive vectors comprises rotating the descriptive vectors using canonical correlations.

51. The system of claim 48, wherein grouping the rotated descriptive vectors comprises grouping the clusters into an unsupervised classification using statistical determination.

52. The system of claim 45, wherein projecting the information collection as clusters comprises displaying a summary view of the information collection, the summary view being created based on the information collection projected as the clusters as well as on the contents of a query used to produce the information collection.

53. A method of steering the analysis of a collection of documents, comprising:
receiving a collection of documents, the collection being produced by a query against a database;
creating a numeric vector for each document of the collection;
encoding the query to create an incidence matrix;
rotating the numeric vectors to match the incidence matrix;
grouping the rotated numeric vectors into clusters; and
projecting the clusters to create a summary view of the documents.

54. The method of claim 53, wherein vector coordinates of the numeric vector reflect differences in contents of the documents of the collection.

55. The method of claim 53, wherein the rotating comprises rotating the numeric vectors using a canonical correlations technique.

56. The method of claim 53, wherein the grouping comprises grouping the clusters into an unsupervised classification using statistical determination.

57. The method of claim 53, wherein the summary view of the documents is created based on the collection of documents projected as the clusters as well as on the contents of a query is used to produce the collection of documents.

58. A computer readable medium embodying computer program code which, when loaded in a computer, causes the computer, in operation, to:
represent contents of a query, used to retrieve a collection of documents, as a matrix;
rotate document vectors associated with the documents to match the matrix to produce a matrix of rotated document vectors;
group the rotated document vectors into clusters; and
project the clusters to display visual information of the documents.

59. A computer readable medium in accordance with claim 58, wherein the computer program code is further configured to cause the computer to label the clusters, the labels representing contents of the query.

60. A computer readable medium in accordance with claim 58, wherein representing contents of a query comprises separating the query into atomic terms, and constructing the matrix with the atomic terms.

61. A computer readable medium in accordance with claim 60, wherein the computer program code is further configured to cause the computer to classify the atomic terms as topic words by increasing a topicality value associated with the respective atomic terms.

62. A computer readable medium in accordance with claim 60, wherein rotating document vectors comprises changing the document vectors to reflect contents of the query.

63. A computer readable medium in accordance with claim 58, wherein rotating document vectors comprises rotating the document vectors using canonical correlations.

64. A computer readable medium in accordance with claim 58, wherein grouping rotated document vectors comprises grouping the rotated document vectors based on contents of the query.

65. A computer readable medium in accordance with claim 58, wherein grouping rotated document vectors comprises grouping documents associated with the rotated document vectors into an unsupervised classification using a statistical technique.

66. A computer readable medium in accordance with claim 58, wherein displaying visual information comprises displaying a summary view of the documents, the summary view being created based on contents of the documents projected into the clusters as well as on the contents of a query used to produce the clusters.

67. A method of representing information objects in a concept-space, comprising:
receiving a query against a database;
obtaining a query result set having a collection of information objects from the database, the collection of information objects related to one or more concepts;
grouping the collection of information objects into an unsupervised classification to produce a plurality of clusters, each cluster having a set of information objects from the collection, the grouping being performed based on the one or more concepts; and
projecting the clusters to display visual information of the collection of information objects, each of the clusters identifying a concept, each cluster includes information objects related to the concept identified by the cluster.

68. A method of claim 67, wherein the grouping comprises grouping information objects comprising a plurality of concepts across a plurality of clusters depending on concepts indicated by the information objects.

69. A method of claim 68, wherein computational complexity of the grouping comprises the cost of evaluating each of the information objects against a concept-space of interest.

70. A method of claim 67, wherein grouping the collection into clusters comprises spatially arranging the clusters based on similarity of information objects.

71. A method of claim 67, wherein the projecting comprises projecting each concept at a single location.

72. A method of claim 67, further comprising combining concepts for each of the information objects to produce a summary view of the concepts.

73. A method of steering the analysis of a collection of information objects, comprising:
receiving a collection of information objects, the information objects representing one or more concepts;
grouping the collection of information objects into a plurality of clusters, each cluster representing a single concept and having a set of information objects from the collection; and
projecting the clusters to display visual information of the collection of information objects.

74. A method of claim 73, wherein the grouping comprises grouping information objects comprising a plurality of concepts across a plurality of clusters depending on concepts indicated by the information objects.

75. A method of claim 73, wherein grouping the collection into clusters comprises spatially arranging the clusters based on similarity of information objects.

76. A method of claim 73, wherein the projecting comprises projecting each concept at a single location.

77. A method of claim 73, further comprising combining concepts for each of the information objects to produce a summary view of the concepts.

78. A computer-readable medium comprising computer usable-code, when loaded in a computer, causes the computer, in operation to:
receive a collection of information objects, the information objects representing one or more concepts;
group the collection of information objects into a plurality of clusters, each cluster representing a single concept and having a set of information objects from the collection; and
project the clusters to display visual information of the collection of information objects.

79. A computer-readable medium of claim 78, wherein grouping the collection of information objects comprises grouping information objects comprising a plurality of concepts across a plurality of clusters depending on concepts indicated by the information objects.

80. A computer-readable medium of claim 78, wherein grouping the collection comprises spatially arranging the clusters based on similarity of information objects.

81. A method comprising:
semantically filtering a set of documents in a database to extract a set of semantic concepts, to improve an efficiency of a predictive relationship to its content, based on at least one of word frequency, overlap and topicality;
defining a topic set, said topic set being characterized as the set of semantic concepts which best discriminate the content of the documents containing them, said topic set being defined based on at least one of word frequency, overlap and topicality;
forming a matrix with the semantic concepts contained within the topic set defining one dimension of said matrix and the semantic concepts contained within the filtered set of documents comprising another dimension of said matrix;
calculating matrix entries as the conditional probability that a document in the database will contain each semantic concept in the topic set given that it contains each semantic concept in the filtered set of documents;
providing the matrix entries as document vectors to interpret the document contents of the database;
inputting query terms;
augmenting the topic set by the query terms;
making an incidence matrix of query terms for the documents;
rotating the document vectors to match the incidence matrix; and
clustering and projecting the rotated document vectors.
